(19) United States
(12) Patent Application Publication
(10) Pub. No.: US 2019/0114814 A1
(43) Pub. Date: Apr. 18, 2019

(54) METHOD AND SYSTEM FOR CUSTOMIZATION OF PICTURES ON REAL TIME DYNAMIC BASIS

(71) Applicant: Yagerbomb Media Pvt. Ltd., Mumbai (IN)

(72) Inventors: Prateek LAL, Vadodara (IN); Yuvraj BHALLA, Mumbai (IN); Sumit KUMAR, Bhagalpur (IN)

(21) Appl. No.: 15/980,358

(22) Filed: May 15, 2018

(30) Foreign Application Priority Data
Oct. 18, 2017 (IN) 201721037039

(51) Int. Cl. G06T 11/00; H04L 29/06; G06T 5/00

(52) U.S. Cl. CPC G06T 11/001; G06Q 50/01; G06T 5/002; H04L 65/602

(57) ABSTRACT

The present disclosure provides a computer-implemented method and an image customization system for a real-time customization of a single image of the at least two users located at different geographical locations. The system receives a data associated with an individual preview image of the at least two users and at least two portable communication devices to click a single image of the two users located at the different geographical locations. The system displays options to the user on the corresponding portable communication devices to set the background of the single image. The system receives an input from the at least one user involved in clicking the real-time single image. The system performs one or more operations on the real-time single image of the at least two users to set the background.

### TECHNICAL FIELD

The present disclosure relates to a field of photography and videography. More specifically, the present disclosure relates to a method and system for customization of a single image of the at least two users located at different geographical locations on the real-time dynamic basis.

### BACKGROUND

With the advancements in technology over the last few years, a large number of portable communication devices have surfaced in the market. One of the portable communication devices which are being used constantly is a smartphone. Nowadays, the users are heavily dependent on their smartphones to perform various tasks such as taking a cab, instant messaging, clicking pictures and the like. These smartphones are equipped with a camera which allows the users to click pictures in real time. With the advent of social media, the users spend a lot of time in clicking pictures on their smartphone for posting on various social media platforms. Typically, two or more users need to be present at the same location or together in order to get a picture clicked. The picture may be taken with a front camera or a back camera in real time. The users may want to get a picture clicked with some other user who is present in a different geographical location. However, the currently available systems are limited to clicking pictures with users present in the same location in front of the same camera. There is a constant need to overcome this problem.

### SUMMARY

In a first example, the present disclosure provides a computer-implemented method for a real-time customization of a single image of at least two users located at different geographical locations. The computer-implemented method includes a first step of receiving a data associated with individual preview image of the at least two users located at different geographical locations and at least two portable communication devices. The computer-implemented method includes a second step of clicking the single image of the at least two users located at the different geographical locations. The computer-implemented method includes a third step of displaying one or more options to the at least one user on the corresponding portable communication devices to set the background of the single image of the at least two users located at different geographical locations. The computer-implemented method includes a fourth step of receiving an input from the at least one user involved in clicking the real-time single image. The computer-implemented method includes a fifth step of performing one or more operations on the real-time single image of the at least two users based on the input from the at least one user to set the background of the real-time single image. A first portable communication device of the at least two portable communication devices is associated with a first user and a second portable communication device of the at least two portable communication devices is associated with a second user. The data is received after creating a connection between the first portable communication device and the second portable communication device. The single image of the at least two users is clicked in real time based on an input from the at least one user through a corresponding portable communication device. The single image of the at least two users is clicked after synchronizing the one or more parameters associated with the preview image of the at least two users and hardware elements of the at least two portable communication devices in real time. The single image of the at least two users is clicked in real time based on an input from the at least one user through a corresponding portable communication device. The single image of the at least two users is clicked after synchronizing the one or more parameters associated with the preview image of the at least two users and hardware elements of the at least two portable communication devices in real time. The one or more options is displayed in real time on the mobile applications associated with the image customization system. The input is received in correspondence to the one or more options displayed on the portable communication device to set the background. The input is received in real time. The input is received in correspondence to the one or more options displayed on the portable communication device to set the background. The input is received in real time. The one or more operations include detecting co-ordinates of body parts of the at least one user by utilizing image processing techniques and algorithms, cropping the body parts of the at least one user from the clicked single image of the at least two users by using image cropping and scaling algorithms, setting the background of the clicked single image of the at least two users located at different geographical locations based on the input of the at least one user to set the background in real time and by utilizing the cropped data associated with the body parts of the at least one user and denoising the single image of the at least two users located at different geographical locations after setting the selected background. The co-ordinates of the body parts of the at least one user are detected to crop the body parts of the at least one user from the clicked single image of the at least two users located at different geographical locations. The cropping of the body parts is done in real time to set the background of the clicked single image with the corresponding background selected by the at least one user by responding to the one or more options in real time. The denoising is done to remove the undesired signal from the clicked single image by using image processing techniques and algorithms in real time.

In an embodiment of the present disclosure, the one or more options is related to set a random background, setting the background according to original background, setting the background based on the identified location of the original background scenes, setting the background with a combination of multiple backgrounds, setting the background based on the interest of the users, setting the background based on the festive events, setting the background based on the demographic information of the users and selection of background from the one or more sources. The one or more sources include storage media of the portable communication devices, gallery, album, photos of the portable communication devices and one or more online platforms.

In an embodiment of the present disclosure, the computer-implemented method further includes synchronizing a plurality of parameters to set the background of the real-time single image according to the cropped body parts of the users. The synchronization is done by using synchronizing techniques and algorithms. The plurality of parameters includes color, contrast, saturation, brightness, autofocus and ISO of the cropped body parts and the selected background.

In an embodiment of the present disclosure, the connection between the at least two portable communication devices is created by utilizing the unique code generated on the first portable communication device associated with the first user.

In an embodiment of the present disclosure, the preview image of the at least two user is rendered on the corresponding portable communication devices. The camera of the first portable communication device is triggered when a first signal generator circuitry sends a signal to trigger the camera of the first portable communication device and the camera of the second portable communication device is triggered when a second signal generator circuitry sends a signal to trigger the camera of the second portable communication device.

In an embodiment of the present disclosure, the computer-implemented method further includes analyzing the data associated with the individual preview image of the at least two users located at different geographical locations and the data associated with at least two portable communication devices. The analyzing is done to match co-ordinates of the single image of at least the two users with co-ordinates of display screen of the corresponding portable communication devices.

In an embodiment of the present disclosure, the computer-implemented method further includes storing the data associated with the individual preview image of the at least two users located at different geographical locations, the data associated with at least two portable communication devices and the customized single image of the at least two users. The storing is done in real time.

In an embodiment of the present disclosure, the one or more parameters associated with the preview image of the at least two users and hardware elements of the at least two portable communication devices includes camera features, image, format of images, co-ordinates of image, lightning conditions and screen dimension.

In an embodiment of the present disclosure, the computer-implemented method further includes customizing the single image of the at least two users clicked in real time. At least one of the at least two users customize the single image by adding one or more filters to the single image in real time by rotating the image in left, right, top and bottom directions. The one or more filters is in form of video, gif, 3-d image, 2-d image, animation or a combination of images and videos.

In an embodiment of the present disclosure, the computer-implemented method further includes recommending the list of backgrounds to the at least one user based on at least one parameter. The at least one parameter includes demographic information of the user, festive events, social profile of the user, current location of the user. The recommendation is done in real time.

In a second example, a computer system is provided. The computer system may include one or more processors and a memory coupled to the one or more processors. The memory may store instructions which, when executed by the one or more processors, may cause the one or more processors to perform a method. The method is configured for a real-time customization of a single image of at least two users located at different geographical locations. The method includes a first step of receiving a data associated with individual preview image of the at least two users located at different geographical locations and at least two portable communication devices. The method includes a second step of clicking the single image of the at least two users located at the different geographical locations. The method includes a third step of displaying one or more options to the at least one user on the corresponding portable communication devices to set the background of the single image of the at least two users located at different geographical locations. The method includes a fourth step of receiving an input from the at least one user involved in clicking the real-time single image. The method includes a fifth step of performing one or more operations on the real-time single image of the at least two users based on the input from the at least one user to set the background of the real-time single image. A first portable communication device of the at least two portable communication devices is associated with a first user and a second portable communication device of the at least two portable communication devices is associated with a second user. The data is received after creating a connection between the first portable communication device and the second portable communication device. The single image of the at least two users is clicked in real time based on an input from the at least one user through a corresponding portable communication device. The single image of the at least two users is clicked after synchronizing the one or more parameters associated with the preview image of the at least two users and hardware elements of the at least two portable communication devices in real time. The single image of the at least two users is clicked in real time based on an input from the at least one user through a corresponding portable communication device. The single image of the at least two users is clicked after synchronizing the one or more parameters associated with the preview image of the at least two users and hardware elements of the at least two portable communication devices in real time. The one or more options is displayed in real time on the mobile applications associated with the image customization system. The input is received in correspondence to the one or more options displayed on the portable communication device to set the background. The input is received in real time. The input is received in correspondence to the one or more options displayed on the portable communication device to set the background. The input is received in real time. The one or more operations include detecting co-ordinates of body parts of the at least one user by utilizing image processing techniques and algorithms, cropping the body parts of the at least one user from the clicked single image of the at least two users by using image cropping and scaling algorithms, setting the background of the clicked single image of the at least two users located at different geographical locations based on the input of the at least one user to set the background in real time and by utilizing the cropped data associated with the body parts of the at least one user and denoising the single image of the at least two users located at different geographical locations after setting the selected background. The co-ordinates of the body parts of the at least one user are detected to crop the body parts of the at least one user from the clicked single image of the at least two users located at different geographical locations. The cropping of the body parts is done in real time to set the background of the clicked single image with the corresponding background selected by the at least one user by responding to the one or more options in real time. The denoising is done to remove the undesired signal from the clicked single image by using image processing techniques and algorithms in real time.

In a third example, a computer-readable storage medium is provided. The computer-readable storage medium encodes computer executable instructions that, when executed by at least one processor, performs a method. The method is configured for a real-time customization of a single image of at least two users located at different geographical locations. The method includes a first step of receiving a data associated with individual preview image of the at least two users located at different geographical locations and at least two portable communication devices. The method includes a second step of clicking the single image of the at least two users located at the different geographical locations. The method includes a third step of displaying one or more options to the at least one user on the corresponding portable communication devices to set the background of the single image of the at least two users located at different geographical locations. The method includes a fourth step of receiving an input from the at least one user involved in clicking the real-time single image. The method includes a fifth step of performing one or more operations on the real-time single image of the at least two users based on the input from the at least one user to set the background of the real-time single image. A first portable communication device of the at least two portable communication devices is associated with a first user and a second portable communication device of the at least two portable communication devices is associated with a second user. The data is received after creating a connection between the first portable communication device and the second portable communication device. The single image of the at least two users is clicked in real time based on an input from the at least one user through a corresponding portable communication device. The single image of the at least two users is clicked after synchronizing the one or more parameters associated with the preview image of the at least two users and hardware elements of the at least two portable communication devices in real time. The single image of the at least two users is clicked in real time based on an input from the at least one user through a corresponding portable communication device. The single image of the at least two users is clicked after synchronizing the one or more parameters associated with the preview image of the at least two users and hardware elements of the at least two portable communication devices in real time. The one or more options is displayed in real time on the mobile applications associated with the image customization system. The input is received in correspondence to the one or more options displayed on the portable communication device to set the background. The input is received in real time. The input is received in correspondence to the one or more options displayed on the portable communication device to set the background. The input is received in real time. The one or more operations include detecting co-ordinates of body parts of the at least one user by utilizing image processing techniques and algorithms, cropping the body parts of the at least one user from the clicked single image of the at least two users by using image cropping and scaling algorithms, setting the background of the clicked single image of the at least two users located at different geographical locations based on the input of the at least one user to set the background in real time and by utilizing the cropped data associated with the body parts of the at least one user and denoising the single image of the at least two users located at different geographical locations after setting the selected background. The co-ordinates of the body parts of the at least one user are detected to crop the body parts of the at least one user from the clicked single image of the at least two users located at different geographical locations. The cropping of the body parts is done in real time to set the background of the clicked single image with the corresponding background selected by the at least one user by responding to the one or more options in real time. The denoising is done to remove the undesired signal from the clicked single image by using image processing techniques and algorithms in real time.

### BRIEF DESCRIPTION OF THE FIGURES

Having thus described the invention in general terms, reference will now be made to the accompanying drawings, which are not necessarily drawn to scale, and wherein:

FIG. 1 illustrates an interactive computing environment between users and one or more components for customization of single image on real-time dynamic basis, in accordance with various embodiments of the present disclosure; and

FIG. 2 illustrates a flow chart for a method for customization of the single image on real-time dynamic basis, in accordance with various embodiments of the present disclosure; and

FIG. 3 illustrates a block diagram of a computing device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

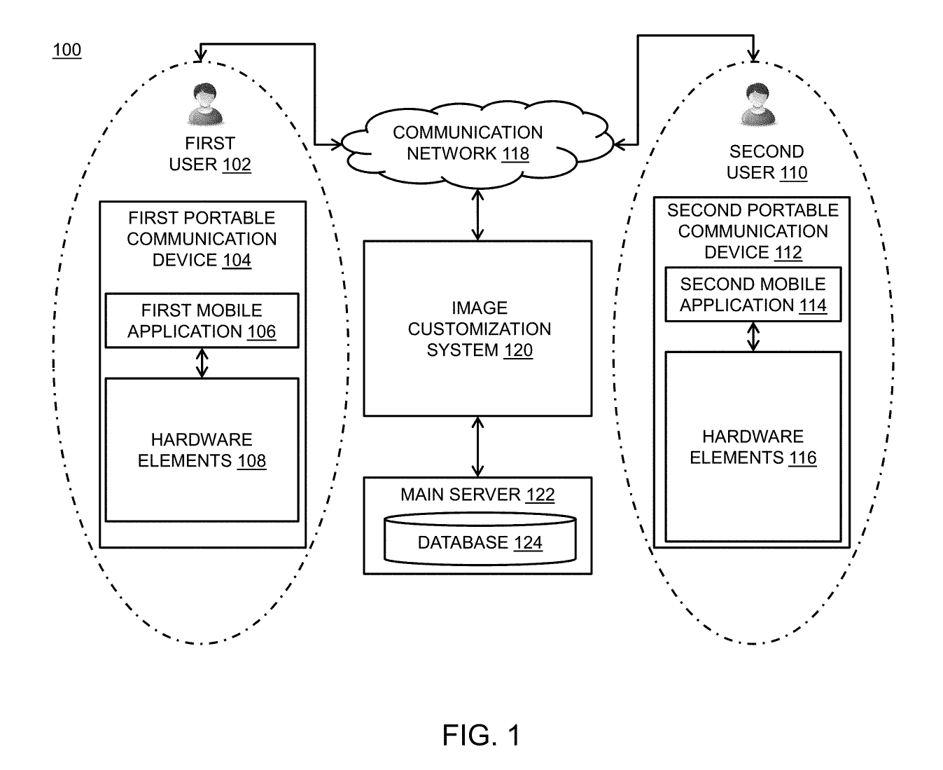

FIG. 1 illustrates a general overview of an interactive computing environment 100 for customization of an image of at least two users located at different geographical locations, in accordance with various embodiments of the present disclosure. The interactive computing environment 100 shows a system which facilitates in clicking and customizing the single image of the at least two users located at different geographical locations. In addition, the interactive computing environment 100 shows the system to add or change the background of the clicked single image of the at least two users in real time. The interactive computing environment 100 includes a first portable communication device 104, a first mobile application 106, and first hardware elements 108. In addition, the interactive computing environment 100 includes a second portable communication device 112, a second mobile application 114, second hardware elements 116 and a communication network 118. Further, the interactive computing environment 100 includes an image customization system 120, a main server 122 and a database 124. The hardware elements 108, 116 include but may not be limited to the mic, camera, display, signal generator circuitry and one or more sensors.

The interactive computing environment 100 includes the first portable communication device 104. The first portable communication device 104 is associated with a first user 102. In general, the user can be any person or individual who wants to take a picture along with another user, when both the users are at different geographical locations. In general, the portable communication device is any mobile device used for the communication purpose. Further, the first portable communication device 104 includes the first mobile application 106. The first mobile application 106 is installed on the first portable communication device 104. In general, the mobile application performs various tasks such as handling notifications and connectivity. Also, the mobile application is programmed in different languages for different platforms. Moreover, the use of the mobile application in online mode and offline mode depends on the type of application used. In an example, the mobile applications are used for entertainment, productivity, marketing purpose and the like.

In an embodiment of the present disclosure, the first mobile application 106 is associated with the first hardware elements 108. The first hardware elements 108 include but may not be limited to the mic, camera, display, first signal generator circuitry and the one or more sensors. The first hardware elements 108 are the main elements of the first portable communication device 104 that are synchronized with the first mobile application 106 in real time dynamic basis.

In an embodiment of the present disclosure, a second user 110 is present in any different geographical location. The second user 110 has the second portable communication device 112. The second portable communication device 112 is any mobile device having a camera and network connectivity. Further, the second portable communication device 112 includes the second mobile application 114. The second mobile application 114 is installed on the second portable communication device 112. The second mobile application 114 performs various tasks such as handling notifications and connectivity. The second mobile application 114 is programmed in different languages for different platforms.

Further, the second mobile application 114 is associated with the second hardware elements 116. The second hardware elements 116 include but may not be limited to the mic, camera, display, second signal generator circuitry and the one or more sensors. The second hardware elements 116 are the main elements of the second portable communication device 112 that are synchronized with the second mobile application 114 on real-time dynamic basis.

Furthermore, the interactive computing environment 100 includes the communication network 118. The communication network 118 is responsible for connecting the first portable communication device 104 with the second portable communication device 112. Also, the communication network 118 is associated with the image customization system 120. The communication network 118 handles all the tasks related to the connectivity of the image customization system 120. The communication network 118 provides facilities such as compression for lesser connectivity zones for seamless connection between the devices.

In an embodiment of the present disclosure, the image customization system 120 receives a data associated with individual preview image of the at least two users located at different geographical locations. In addition, the image customization system 120 receives the data associated with the at least two portable communication devices. The data includes a first set of data and a second set of data. Further, the first portable communication device 104 of the at least two portable communication device is associated with to the first user 102. The second portable communication device 112 of the at least two portable communication device is associated with the second user 110. Moreover, the data is received after creating a connection between the first portable communication device 104 and the second portable communication device 112.

The image customization system 120 receives the first set of data associated with the first portable communication device 104. In an embodiment of the present disclosure, the first set of data includes information regarding the first portable communication device 104. In an example, the first set of data includes but may not be limited to camera quality, camera resolution, display size, screen size, operating system, RAM, ROM, type of sensors and the accuracy of sensors. In another example, the first set of data includes the information of the first hardware elements 108 associated with the first portable communication device 104. In yet another example, the first set of data comprises the working status of the first hardware elements 108 associated with the first portable communication device 104. In an example, the hardware elements (108, 116) includes but may not be limited to the mic, front camera, rear camera, display, speaker, audio jack, one or more integrated chip (IC), battery and SIM cards. Also, the first set of data includes hardware as well as software information of the first portable communication device 104.

In an embodiment of the present disclosure, the image customization system 120 triggers the camera associated with the first portable communication device 104. In an embodiment of the present disclosure, the camera is triggered for rendering a real-time preview of an image of the first user 102. The camera is triggered when a signal generator circuitry associated with the first portable communication device 104 generates a signal to trigger the camera of the first portable communication device 104. In an example, the front camera is triggered for rendering the real-time preview of the image of the first user 102. In another example, the rear camera is triggered for rendering the real-time preview of the image of the first user 102. In an embodiment of the present disclosure, the camera is triggered to show the appearance of the first user 102 when the first user 102 wants to click a picture with the at least second user 108 located at the different geographical location. In an embodiment of the present disclosure, the preview of the image of the first user 102 is rendered to the mobile application 106 on real-time dynamic basis.

The image customization system 120 collects the second set of data associated with the body of the first user 102 after performing one or more operations on the image of the first user 102. In addition, the second set of data includes processed data associated with the body on the image of the first user 102. In addition, the second set of data is the processed data associated with the body of the first user 102 after performing the one or more operations on the preview image of the first user 102. In an example, the processed data include but may not be limited to cropped data or co-ordinate data of face, neck, chest, shoulder, hands and legs. In an example, the one or more operations include but may not be limited to image processing, simplifying, cropping, detecting, transforming, regenerating, scaling, and filtering. In another example, the one or more operations are performed to collect required data from the stream data of the user 102. The image customization system 120 detects the one or more parts of the body of the first user 102 using detecting techniques and algorithms. In an example, the image customization system 120 uses face detecting techniques and algorithms to detect the face of the first user 102. The image customization system 120 detects the face of the first user 102 to get the preview co-ordinates of the detected face. Further, the co-ordinates of the detected face are scaled and transformed to actual screen co-ordinates of the first portable communication device 104 based on the first set of data. In an example, the image customization system 120 analyzes and maps the co-ordinates of the detected face of the first user 102 with the co-ordinates of the screen of the first portable communication device 104. Further, the image customization system 120 crops and stores the required data from the image of the first user 102 for further operations. The required data is the second set of data extracted after performing one or more operations on the image of the first user 102 In an embodiment of the present disclosure, the second set of data is passed on to the connection component in real time using the communication network 118.

The image customization system 120 generates a request to the at least second portable communication device 112 associated with the second user 110 located at a different geographical place for taking a picture with the first user 102 in real time. In general, the request to the at least second portable communication device 112 is sent based on the input of the first user 102 for the selection of the second user. In another embodiment of the present disclosure, the request may be sent to one or more users for taking a single picture with the one or more users located at one or more different geographical places. Further, the request is sent to the at least second portable communication device 110 by utilizing the unique value generated on the first portable communication device 104. Furthermore, the request is sent for the mutual pairing of the first portable communication device 104 with the at least second portable communication device 112. Moreover, the request is sent to create a connection between the at least first portable communication device 104 and the second portable communication device 110. Also, the request is sent through the mobile application 106 installed in the first portable communication device 104.

In an embodiment of the present disclosure, the image customization system 120 is associated with the main server 122 through the communication network 118. In an embodiment of the present disclosure, the communication network 118 enables the image customization system 120 to gain access to the internet for transmitting the data to the main server 122 and the second portable communication device 112. Moreover, the communication network 118 provides a medium to transfer the first set of data and the second set of data between the image customization system 120 and the main server 122. Further, the medium for communication may be infrared, microwave, radio frequency (RF) and the like.

In an embodiment of the present disclosure, the image customization system 120 has the capability to work in average or below average network conditions such as 2G. In an example, the portable communication devices transmit the data through the communication network 118 using specially designed hardware run algorithms for poor network conditions. The image customization system 120 senses the poor network conditions and compresses the data on its own using the inbuilt hardware run algorithm. The same hardware run algorithm is applied to the other connected device in a situation of poor network conditions. The sensing of the poor network conditions and transmitting the data using compression techniques is done on real-time dynamic basis. The communication network 118 is associated with the main server 122.

In an embodiment of the present disclosure, the image customization system 120 receives the first set of data associated with the second portable communication device 112. In addition, the first set of data includes the data associated with the second hardware elements 118. Further, the image customization system 120 triggers a camera associated with the second portable communication device 112 for rendering the real-time preview of an image of the second user 110. The camera is triggered when a signal generator circuitry associated with the second portable communication device 112 generates a signal to trigger the camera of the second portable communication device 112. Moreover, the image customization system 120 collects a second set of data associated with the body of the second user 110 after performing the one or more operations on the image of the second user 110. The one or more operations are performed based on the first set of data associated with the second portable communication device 112 and the image of the second user 110. The second set of data is collected in real time.

In an embodiment of the present disclosure, the second set of data of the first user 102 is shared with the second set of data of the second user 110 through the communication network 118. In another embodiment of the present disclosure, the second set of data of the first user 102 is shared with the one or more users on one or more portable communication devices to which the first user 102 is connected. The second set of data is shared to click a real-time picture of the first user 102 with the second user 110 when the second user 110 is located at the different geographical location. The first user 102 has the data of the face of the first user 102 as well as the second user 110. In addition, the second user 110 has the second set of data of the second user 110 as well as the first user 102.

In an embodiment of the present disclosure, the image customization system 120 analyzes the data associated with the individual preview image of the at least two users located at different geographical locations. In addition, the image customization system 120 analyzes the data associated with the at least two portable communication devices. In an embodiment of the present disclosure, the analyzing is done to match co-ordinates of the single image of at least the two users with co-ordinates of the display screen of the corresponding portable communication devices.

In an embodiment of the present disclosure, the image customization system 120 analyzes the first set of data and the second set of data by using image processing techniques and algorithms. In addition, the first set of data and the second set of data are analyzed to match co-ordinates of the image of the at least two users with co-ordinates of the screen of the corresponding portable communication devices. In an example, the co-ordinates of the image of the first user 102 are matched with the co-ordinates of the screen based on the size of the screen of the first portable communication device 104. In another example, the co-ordinates of the image of the second user 110 are matched with the co-ordinates of the screen based on the size of the screen of the second portable communication device 112.

In an embodiment of the present disclosure, the image customization system 120 clicks the single image of the at least two users located at the different geographical locations. In addition, the real-time single image of the at least two users is clicked based on an input from the at least one user to click the image through the corresponding portable communication device. Further, the single image of the at least two users is clicked after synchronizing one or more parameters. In addition, the one or more parameters are associated with the preview image of the at least two users and hardware elements 108, 116 of the at least two portable communication devices in real time. In an example, the one or more parameters include camera features, image, format of images, co-ordinates of image, lightning conditions and screen dimension. In an embodiment of the present disclosure, the image customization system 120 is capable of synchronizing the camera of the first portable communication device 104 with the camera of the second portable communication device 112. In an example, the synchronization of the camera of both the portable communication devices is done to take the single image of both the users in single file format on the real time dynamic basis. In an example, the camera of the first portable communication device 104 captures the image in png format. In addition, the camera of the second portable communication device 112 captures the image in jpeg format. The image customization system 120 is capable of taking the single image in the single file format on the real-time dynamic basis.

In an example, the first user 102 clicks the real time single image with the second user 110 located at the different geographical location through the mobile application 106 installed in the first portable communication device 104. In another example, the second user 110 clicks the real-time single image with the first user 102 located at the different geographical location through the mobile application 114 installed in the second portable communication device 112.

In an embodiment of the present disclosure, the image customization system 120 synchronizes the camera of the at least two portable communication devices. In an example, the camera of the first portable communication device 104 and the second portable communication device 112 may be of different resolutions. The image customization system 120 has to deal with the different resolutions of the cameras. In an example, a smartphone has a camera quality of around 16 megapixels. Another camera might be having a Carl Zeiss lens of resolution as high as 41 megapixels. The image customization system 120 synchronizes the different resolution cameras to take a single real-time image such that the image is of the highest resolution possible on the real-time dynamic basis. The one or more hardware run algorithms end up doing this task using specialized mechanism for taking the picture to the best possible resolution.

In an embodiment of the present disclosure, the image customization system 120 is capable of synchronizing the pictures having different lighting conditions. In an example, a person sitting in the USA is clicking a picture in sunlight. Another person sitting in India is using a low light camera smartphone to click the picture at night. The image customization system 120 is capable of capturing a single picture of at least two users by adjusting the lighting condition of the two separate pictures on real-time dynamic basis.

In another embodiment of the present disclosure, the image customization system 120 is capable of synchronizing screen dimensions and densities of portable communication devices on the real-time dynamic basis. In an example, five users located at different geographical places want to take a single real-time image with each other. The dimension and density of screen of portable communication devices of each user of the five users are different from each other. The image customization system 120 synchronizes the screen sizes based on the second set of data collected from different portable communication devices to take a real-time single image of the five users.

In yet another embodiment of the present disclosure, the cameras of the portable communication devices are working on the different operating system. In an example, a smartphone camera of Samsung Galaxy S7 has an Android operating system. The second camera is of Apple iPhone 7 having an IOS operating system. Both the mobile devices are different from each other on the basis of their operating system. The image customization system 120 is responsible to seamlessly integrate the hardware cameras of the different devices and capture a single picture of at least two users located at different geographical locations on the real-time dynamic basis. In yet another embodiment of the present disclosure, the image customization system 120 is capable of capturing a single picture from different facing cameras on the different smartphones on the real-time dynamic basis. In an example, a person is taking a picture from the front camera of the smartphone A. Another person might be taking a picture from the back camera of the smartphone B. The front and back-facing cameras on the two different smartphones have different properties. The image customization system 120 captures a single picture of both the persons such that the picture appears to be taken at a single geographical location on the real-time dynamic basis by synchronizing the facing of cameras.

In an embodiment of the present disclosure, the image customization system 120 customizes the single image of the at least two users located at different geographical locations. In an embodiment of the present disclosure, the image customization system 120 customizes the single image of the at least two users based on the input from one of the at least two users. In an example, the customization is done by adding one or more filters to the image in real time. Further, the customization is done by rotating the image in left, right, top and bottom directions. In an example, the one or more filters is in the form of video, gif, 3-D image, 2-D image, animation or a combination of image and video. In addition, the one or more filters may in the form of 3-d model, 2-d model, AR-VR components. In an example, the user A wants to add a certain filter to enhance the beauty of the image. The image customization system 120 gives the user A an option to add any filter of his choice in real time. The one or more filters added may be pre-defined in the mobile application. The one or more filters may also be added with the support of the third-party applications.

In another example, the image customization system 120 allows users to apply different stickers and emoji on the clicked image on the real-time dynamic basis. In addition, the mobile applications have the inbuilt ability to apply special effects in the form of cartoon characters, emoji, and stickers to the picture in real time. Further, the image customization system 120 may also integrate with the third-party applications to further add one or more stickers to the picture in real time.

In an embodiment of the present disclosure, the image customization system 120 customizes the single image by setting a background on the single-clicked image based on the input of the at least one user. In addition, the image customization system 120 sets the background of the clicked single image by utilizing the cropped data associated with the body parts of the at least one user involved in clicking the single image.

In an embodiment of the present disclosure, the single image clicked by the at least one user has a default background of any suitable color, texture and the like. In an example, the color includes but may not be limited to black, red, white, brown, orange, green. In another embodiment of the present disclosure, the single image of the at least two users has the background of any place or location from where the at least one user clicked the image. In yet another embodiment of the present disclosure, any of the at least one user may select the background of his choice. In an embodiment of the present disclosure, the image customization system 120 allows the user to select the background of his choice by giving one or more options.

In an embodiment of the present disclosure, the image customization system 120 display the one or more options to the at least one user on the corresponding portable communication device. In addition, the one or more options are related to set the background of the single image of the at least two users located at different geographical locations. Further, the one or more options are displayed in real time on the mobile applications associated with the image customization system 120. Furthermore, the one or more options are related to setting a random background, change of background according to the original background, setting a background based on the identified location of the original background scenes. Moreover, the one or more options are related to set a combination of multiple backgrounds, setting of background based on the interest of the users, setting the background based on the demographic information of the users. Also, the one or more options are related to the selection of background from the one or more sources. The one or more sources include storage media of the portable communication device, gallery/album/photos of the portable communication device and online platform.

In another embodiment of the present disclosure, the image customization system 120 display the one or more options before clicking the single image of the at least two users located at different geographical locations. The image customization system 120 may display the one or more options when both the user has cropped or co-ordinates data of each other. In an example, the user may choose one or more options regarding change of the background before clicking the single image and get that background on the single image after clicking the image.

In an embodiment of the present disclosure, the image customization system 120 receives an input from the at least one user involved in clicking the real-time single image of the at least two users. In addition, the input is received in correspondence to the one or more options displayed on the portable communication device to set the background. Further, the inputs are received in real time. In an example, the user 102 may choose the one or more options from the list displayed in mobile application 106 on the first portable communication device 104 in real time. The user may choose the option to set the background from the gallery of the corresponding portable communication device. In addition, the user may choose the option to set the random background on the image of the at least two users. Further, the user may choose the option to set one or more other real-time clicked images as a background of the image.

In an embodiment of the present disclosure, the image customization system 120 performs one or more operations on the real-time single image of the at least two users located at different geographical locations. The one or more operations are performed based on the input from the at least one user to set the background of the real-time single image of the at least two users. In an embodiment of the present disclosure, the one or more operations include but may not be limited to detecting, cropping, replacing, synchronizing and denoising. The one or more operations are performed to set the background of the single image clicked by the at least one user in real time based on the input of the at least one user.

In an embodiment of the present disclosure, the image customization system 120 detects the co-ordinates of body parts of the at least one user by utilizing image processing techniques. The co-ordinates of the body parts of the at least one user is detected to crop the body parts of the at least one user from the clicked single image of the at least two users located at different geographical locations. In an example, the body parts include but may not be limited to face, neck, chest, hands, stomach and legs. In an example, the image customization system 120 detects the body parts of the first user 102 and the second user 110 from the image of the at least two users to set the background of single image in real time. In an example, the real-time single image of the at least two users may have two different backgrounds behind the body parts of the first user and the second user. The image customization system 120 may use the single background of the choice of at least one user from the two users as a background image of the clicked single image of the at least two users. In addition, the image customization system 120 may use background behind the first user 102 as a single background of the single-clicked image of the at least two users. Further, the image customization system 120 may use background behind the second user 110 as a single background of the single-clicked image of the at least two users. In an example, the image customization system 120 detects the co-ordinates of body parts of the at least one user based on the setting of background on the clicked single image of the at least two users. In an embodiment of the present disclosure, the image customization system 120 detects the body parts of the at least one user based on the input of at least one user to set the background of the clicked single image of the at least two users.

In an embodiment of the present disclosure, the detected co-ordinates are scaled and transformed in real time to the actual screen co-ordinates of the device using hardware run algorithms. The different sensors of the portable communication devices are used to obtain the co-ordinates of the body parts of the at least one user.

In an embodiment of the present disclosure, the image customization system 120 crops the body parts of the at least one user from the clicked single image of the at least two users by using image cropping and scaling algorithms. In addition, the cropping of the body parts is done in real time to set the background of the clicked single image with the corresponding background selected by the at least one user in real time. In an example, the image customization system 120 crops the body parts of the at least one user to set these body parts on the background selected by the at least one user in real time for the clicked single image. In another embodiment of the present disclosure, the image customization system 120 may scale and crop the selected background according to the body parts of the at least one user to set the background of the clicked single image. In an example, the cropping is done to replace the default background by the corresponding background selected by the at least one user through input on one or more displayed options.

The image customization system 120 sets the background of the clicked single image of the at least two users located at different geographical locations based on the input of the at least one user to set the background in real time. In an example, the image customization system 120 sets the background when any of the at least two users choose an option to set the background of his choice. In an example, the image customization system 120 shows the clicked single image of the at least two users on the mobile application after setting the selected background on the image of the users.

In an embodiment of the present disclosure, the image customization system 120 synchronizes a plurality of parameters to set the background of the real-time clicked single image. In an example, the plurality of parameters is synchronized so that the first user 102 may feel a presence with second user 110 in real time. In an example, the plurality of parameters includes but not limited to color, contrast, saturation, brightness, autofocus and ISO of cropped body parts and the selected background for the clicked single image. In an example, the body parts of the at least two users have high brightness or color contrast than the selected background. Thus, the image customization system 120 synchronizes the brightness or color contrast by creating a balance of brightness or color contrast to body parts of at least two users as well as the selected background of the clicked single image.

In an embodiment of the present disclosure, the image customization system 120 denoises the single image of the at least two users located at different geographical locations after setting the selected background. The denoising is done to remove the undesired signal from the clicked image by using image processing techniques in real time. Further, the image customization system 120 denoises the single image to get a clear image of the at least two users such that the user may feel real-time presence with another user associated with the image. In another embodiment of the present disclosure, the image customization system 120 performs the operation of denoising the single-clicked image preserving the useful aspects of the image. The denoising of the single-clicked image is done on real-time dynamic basis. There are certain methods which result in the denoising of the single-clicked image. In an example, the image customization system 120 performs denoising of the single-clicked image by reducing the ISO settings of the corresponding cameras of the portable communication devices. The lesser ISO settings mean a lesser amount of noise in the image. In another embodiment of the present disclosure, the image customization system 120 shoots in RAW format instead of JPEG format on its own to reduce the amount of noise on the real-time dynamic basis. The denoising operation is done automatically by the image customization system 120.

In an embodiment of the present disclosure, the user may click a plurality of self-portrait pictures by using the corresponding portable communication device. In an embodiment of the present disclosure, the image customization system 120 allows the user to set the desired picture on the front portion and at least one of the plurality of self-portrait pictures on the background of the desired picture. In an example, the user A clicks four self-portrait pictures and finds one as a perfect picture. Thus, the image customization system 120 may allow the user A to set the rest three self-portrait pictures as a background of the perfect picture clicked by the user A in real time. In another embodiment of the present disclosure, the one or more pictures may be clicked through the rear camera or front camera of the portable communication devices associated with the user. The image customization system 120 allows the user by giving one or more options to keep a suitable image of the plurality of images as a foreground image and other images as the background images. In an example, the user may define the number of images to be shown in the background. In another example, the user may click continuous images in real time and the images will be automatically set as the background on the real-time dynamic basis.

In an embodiment of the present disclosure, the image customization system 120 recommends the list of background to the at least one user based on at least one parameter. The at least one parameter comprises demographic information of the user, festive events, social profile of the user. In an embodiment of the present disclosure, the image customization system 120 asks for the demographic information from the user to register the user on the web-based platform associated with the image customization system 120. In an example, the image customization system 120 asks the user to fill the demographic information when the user opens the mobile application first time after installing the application. The demographic information include but may not be limited to name, age, gender, address, birth date, occupation, contact number. In an example, the image customization system 120 may recommend the user with a list of backgrounds based on the demographic information of the users. In an example, the user A register on the web-based platform by providing the demographic information associated with the user. The user mentions 23^{rd} January as a birth date in the demographic information. Thus, the image customization system 120 recommends the list of backgrounds associated with the birthday background to the at least one user when any of the users click the image on 23^{rd} January. In another example, the image customization system 120 may recommend festival related backgrounds when any of the at least two users click a single image on festival dates.

In another embodiment of the present disclosure, the image customization system 120 customizes the real-time clicked single image by editing the image and applying special effects on the real-time dynamic basis. In an example, the image customization system 120 allows the user to edit his image by applying text, pictures and clip art. In an example, the user may apply desired filters available in the mobile application. The image customization system 120 allows the user to add effects such as grayscale, sepia and the like.

In an embodiment of the present disclosure, the image customization system 120 has the facility of merging different backgrounds on the real-time dynamic basis. In an example, a user A is sitting in his room at his home. Another user B is sitting in the classroom. The image customization system 120 allows the users to choose the desired background between the room of user A and the classroom of user B. The image customization system 120 may also merge both the backgrounds to form a completely different background. All these operations are performed on real-time dynamic basis.

In an embodiment of the present disclosure, the image customization system 120 recommends the list of backgrounds to the at least one user based on the location behind the users while clicking the image with other users in real time. In an example, a person clicking an image near a beach may be recommended by the backgrounds related to other beaches. In another embodiment of the present disclosure, the image customization system 120 displays the list of background based on the age group of the users clicking the image. In an example, a child clicking an image will be recommended by the list of background having a cartoon character.

In another embodiment of the present disclosure, the image customization system 120 is associated with a plurality of portable communication devices. In addition, the plurality of portable communication devices is associated with a plurality of users located at different geographical locations. The image customization system 120 allows the plurality of users to take a single picture with other users located at different geographical places on real-time dynamic basis. In an example, the image customization system 120 transfers the data of the first user with other users in real time. Similarly, the image customization system 120 transfers the data of other users with the first user in real time. Thus, all the users have the data of faces of the other users as well as their own to take a single picture with other users in real time. Furthermore, the image customization system 120 synchronizes the cameras of the plurality of portable communication devices to take a single perfect image of the plurality of users located at different locations. Also, the image customization system 120 allows the plurality of users to customize the single perfect image by using the one or more filters in real time. In an embodiment of the present disclosure, the image customization system 120 allows each user of the plurality of users to select the background image of the clicked single image in real time.

The image customization system 120 provides an option to share the real-time single image clicked by the at least two users on the one or more web-based or social-based platforms. In an example, the user A and user B located at different geographical places click a single image using corresponding portable communication devices. The image turns out to be perfect for sharing. Thus, the user A or the user B may share this image on the social-based platform. In an embodiment of the present disclosure, the image may be shared by using the same mobile application which was used by the at least two users for clicking the real-time image. In an example, the user may share this image on any social media platform such as Facebook, WhatsApp and the like. In another example, the image customization system 120 allows the users to locally share the image using data transfer applications such as Xender, Share.it and the like. The one or more images clicked by the users are shared through the communication network 118. In addition, the communication network 118 is associated with the main server 122.

In another embodiment of the present disclosure, the image customization system 120 displays the single-clicked image in augmented reality. The image customization system 120 may customize the image in augmented reality. The image appears to be present in the real world through the camera of the mobile device. The image appears as if the image is present in front of the device. The image may be customized like a physical entity. The image may be further stored and shared to different platforms.

In another embodiment of the present disclosure, the image customization system 120 displays and customizes the clicked image as a hologram on the real-time dynamic basis. The clicked image may be converted into a three-dimensional picture that is created with the help of photographic projection. The image may be customized on the real-time dynamic basis.

In an embodiment of the present disclosure, the main server 122 performs all the tasks related to the handling of the one or more portable communication devices. The main server 122 receives the requests from the one or more portable communication devices and processes these requests. In an example, the main server receives the request from the first portable communications device 104 and the second portable communication device 112. The main server 122 responds to the requests in an efficient manner. In an example, the main server 122 is present inside the image customization system 120. In another example, the main server 122 is remotely located. In addition, the main server 122 comprises the database 124. The database 124 is the storage location of all the data of the system. The database 124 contains the images, the first set of data and the second set of data, cropped data for the future reference and backup purposes. In an embodiment of the present disclosure, the image customization system 120 stores the image of the at least two users, the first set of data associated with the at least two portable communication devices in the database. In addition, the image customization system 120 stores the second set of data associated with the at least two users in the database 124. The image customization system 120 allows the users to retrieve the data from the database 124 by signing up for an account in case the user loses or delete images.

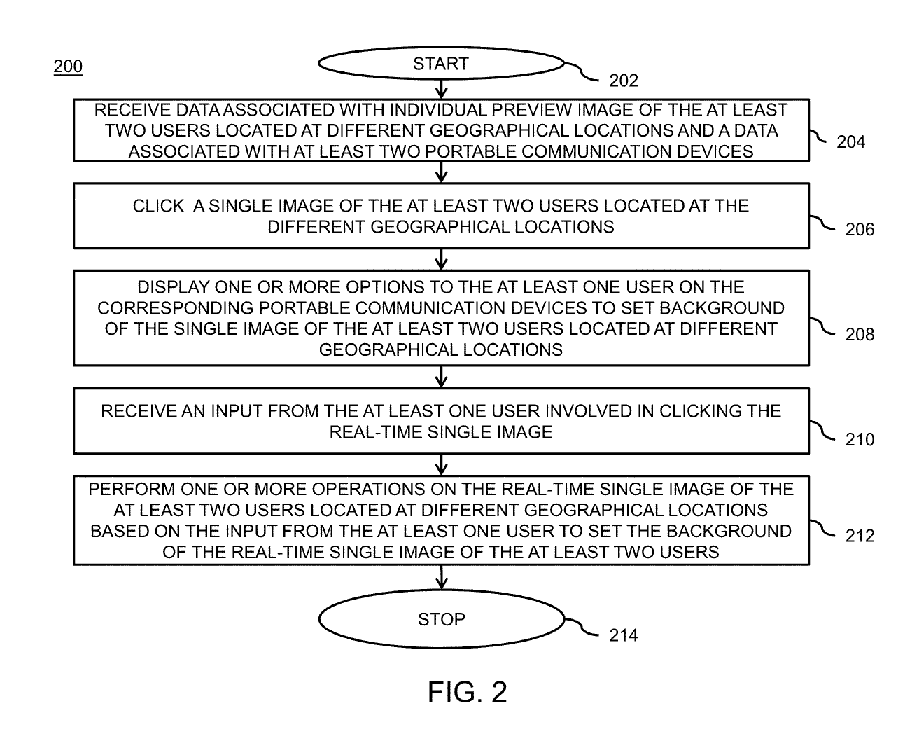

FIG. 2 illustrates a flow chart 200 of a method for the real-time customization of the single image of the at least two users located at different geographical locations, in accordance with various embodiments of the present disclosure. It may be noted that to explain the process steps of flowchart 200, references will be made to the system elements of FIG. 1. It may also be noted that the flowchart 200 may have lesser or more number of steps.

The flowchart 200 initiates at step 202. Following step 202, at step 204, the image customization system 120 receives data associated with individual preview image of the at least two users located at different geographical locations and the data associated with the at least two portable communication devices. At step 206, the image customization system 120 enables clicking of the single image of the at least two users located at the different geographical locations. At step 208, the image customization system 120 displays the one or more options to the at least one user on the corresponding portable communication devices to set the background of the single image of the at least two users located at different geographical locations. At step 210, the image customization system 120 receives the input from the at least one user involved in clicking the real-time single image. At step 212, the image customization system 120 performs the one or more operations on the real-time single image of the at least two users located at different geographical locations based on the input from the at least one user to set the background of the real-time single image of the at least two users. The flow chart 200 terminates at step 214.

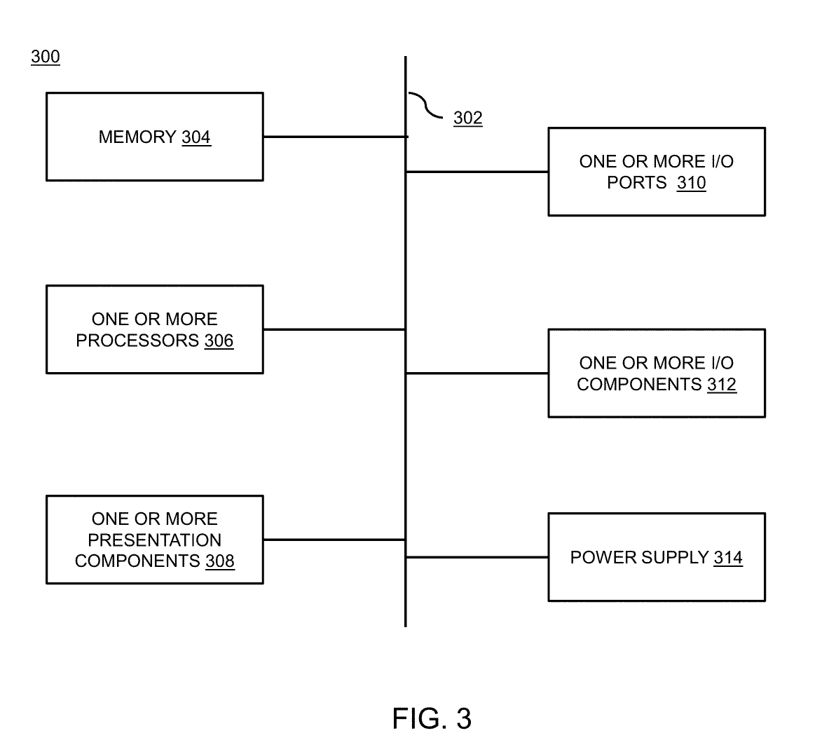

FIG. 3 illustrates a block diagram of a computing device 300, in accordance with various embodiments of the present disclosure. The computing device 300 includes a bus 302 that directly or indirectly couples the following devices: memory 304, one or more processors 306, one or more presentation components 308, one or more input/output (I/O) ports 310, one or more input/output components 312, and an illustrative power supply 314. The bus 302 represents what may be one or more busses (such as an address bus, data bus, or combination thereof). Although the various blocks of FIG. 3 are shown with lines for sake of clarity, in reality, delineating various components is not so clear, and metaphorically, the lines would more accurately be grey and fuzzy. For example, one may consider a presentation component such as a display device to be an I/O component. Also, processors have memory. FIG. 3 is merely illustrative of an exemplary computing device 300 may be used in connection with one or more embodiments of the present disclosure. Distinction is not made between such categories as workstation, server, laptop, hand-held device and the like, as all are contemplated within the scope of FIG. 3 and reference to “the computing device 300.”

The computing device 300 typically includes a computer-readable media. The computer-readable media can be any available media that can be accessed by the computing device 300 and includes both volatile and nonvolatile media, removable and non-removable media. By way of example, and not limitation, the computer-readable media may comprise computer storage media and communication media. The computer storage media includes the volatile and the nonvolatile, the removable and the non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 300. The communication media typically embodies the computer-readable instructions, the data structures, the program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, the communication media includes wired media such as a wired network or direct-wired connection, and wireless media such as acoustic, RF, infrared and other wireless media. Combinations of any of the above should also be included within the scope of the computer readable media.

Memory 304 includes the computer-storage media in the form of volatile and/or nonvolatile memory. The memory 304 may be removable, non-removable, or a combination thereof. Exemplary hardware devices include solid-state memory, hard drives, optical-disc drives and the like. The computing device 300 includes the one or more processors to read data from various entities such as memory 304 or I/O components 312. The one or more presentation components 308 present data indications to a user or other device. Exemplary presentation components include a display device, speaker, printing component, vibrating component and the like. The one or more I/O ports 310 allow the computing device 300 to be logically coupled to other devices including the one or more I/O components 312, some of which may be built in. Illustrative components include a microphone, joystick, game pad, satellite dish, scanner, printer, wireless device and the like.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed:

1. A computer-implemented method for a real-time customization of a single image of at least two users located at different geographical locations, the computer-implemented method comprising:
receiving, at an image customization system with a processor, data associated with individual preview image of the at least two users located at different geographical locations and a data associated with at least two portable communication devices, wherein a first portable communication device of the at least two portable communication devices is associated with a first user and a second portable communication device of the at least two portable communication devices is associated with a second user and wherein the data is received after creating a connection between the first portable communication device and the second portable communication device;
enabling clicking, at the image customization system with the processor, of the single image of the at least two users located at the different geographical locations, wherein the single image of the at least two users is clicked in real time based on an input from the at least one user through a corresponding portable communication device, wherein the single image of the at least two users is clicked after synchronizing the one or more parameters associated with the preview image of the at least two users and hardware elements of the at least two portable communication devices in real time;
displaying, at the image customization system with the processor, one or more options to the at least one user on the corresponding portable communication devices to set the background of the single image of the at least two users located at different geographical locations, wherein the one or more options is displayed in real time on the mobile applications associated with the image customization system;
receiving, at the image customization system with the processor, an input from the at least one user involved in clicking the real-time single image, wherein the input is received in correspondence to the one or more options displayed on the portable communication device to set the background, wherein the input is received in real time;
performing, at the image customization system with the processor, one or more operations on the real-time single image of the at least two users located at different geographical locations based on the input from the at least one user to set the background of the real-time single image of the at least two users, wherein the one or more operations comprises:
detecting, at the image customization system with the processor, co-ordinates of body parts of the at least one user by utilizing image processing techniques and algorithms, wherein the co-ordinates of the body parts of the at least one user are detected to crop the body parts of the at least one user from the clicked single image of the at least two users located at different geographical locations;
cropping, at the image customization system with the processor, the body parts of the at least one user from the clicked single image of the at least two users by using image cropping and scaling algorithms, wherein the cropping of the body parts is done in real time to set the background of the clicked single image with the corresponding background selected by the at least one user by responding to the one or more options in real time;
setting, at the image customization system with the processor, the background of the clicked single image of the at least two users located at different geographical locations based on the input of the at least one user to set the background in real time and by utilizing the cropped data associated with the body parts of the at least one user; and
denoising, at the image customization system with the processor, the single image of the at least two users located at different geographical locations after setting the selected background, wherein the denoising is done to remove the undesired signal from the clicked single image by using image processing techniques and algorithms in real time.

2. The computer-implemented method as claimed in claim 1, wherein the one or more options is related to set a random background, setting the background according to original background, setting the background based on the identified location of the original background scenes, setting the background with a combination of multiple backgrounds, setting the background based on the interest of the users, setting the background based on the festive events, setting the background based on the demographic information of the users, and selection of background from the one or more sources and wherein the one or more sources comprise storage media of the portable communication devices, gallery, album, photos of the portable communication devices and one or more online platforms.

3. The computer-implemented method as claimed in claim 1, further comprising, synchronizing, at the image customization system with the processor, a plurality of parameters to set the background of the real-time single image according to the cropped body parts of the users, wherein the synchronization is done by using synchronizing techniques and algorithms and wherein the plurality of parameters comprises color, contrast, saturation, brightness, autofocus and ISO of the cropped body parts and the selected background.

4. The computer-implemented method as claimed in claim 1, wherein the connection between the at least two portable communication devices is created by utilizing the unique code generated on the first portable communication device associated with the first user.

5. The computer-implemented method as claimed in claim 1, wherein the preview image of the at least two user is rendered on the corresponding portable communication devices, wherein the camera of the first portable communication device is triggered when a first signal generator circuitry sends a signal to trigger the camera of the first portable communication device and the camera of the second portable communication device is triggered when a second signal generator circuitry sends a signal to trigger the camera of the second portable communication device.

6. The computer-implemented method as claimed in claim 1, further comprising analyzing, at the image customization system with the processor, the data associated with the individual preview image of the at least two users located at different geographical locations and the data associated with at least two portable communication devices, wherein the analyzing is done to match co-ordinates of the single image of at least the two users with co-ordinates of display screen of the corresponding portable communication devices.

7. The computer-implemented method as claimed in claim 1, further comprising storing, at the image customization system with the processor, the data associated with the individual preview image of the at least two users located at different geographical locations, the data associated with at least two portable communication devices and the customized single image of the at least two users, wherein the storing is done in real time.

8. The computer-implemented method as claimed in claim 1, wherein the one or more parameters associated with the preview image of the at least two users and hardware elements of the at least two portable communication devices comprises camera features, image, format of images, co-ordinates of image, lightning conditions and screen dimension.

9. The computer-implemented method as claimed in claim 1, further comprising customizing, at the image customization system with the processor, the single image of the at least two users clicked in real time, wherein at least one of the at least two users customize the single image by adding one or more filters to the single image in real time by rotating the image in left, right, top and bottom directions and wherein the one or more filters being in form of video, gif, 3-d image, 2-d image, animation or a combination of images and videos.

10. The computer-implemented method as claimed in claim 1, further comprising, recommending, at the image customization system with the processor, the list of backgrounds to the at least one user based on at least one parameter, wherein the at least one parameter comprises demographic information of the user, festive events, social profile of the user, current location of the user and wherein the recommendation is done in real time.

11. A computer system comprising:
one or more processors; and
a memory coupled to the one or more processors, the memory for storing instructions which, when executed by the one or more processors, cause the one or more processors to perform a method for a real-time customization of a single image of at least two users located at different geographical locations, the method comprising:
receiving, at an image customization system, data associated with individual preview image of the at least two users located at different geographical locations and a data associated with at least two portable communication devices, wherein a first portable communication device of the at least two portable communication devices is associated with a first user and a second portable communication device of the at least two portable communication devices is associated with a second user and wherein the data is received after creating a connection between the first portable communication device and the second portable communication device;
enabling clicking, at the image customization system, of the single image of the at least two users located at the different geographical locations, wherein the single image of the at least two users is clicked in real time based on an input from the at least one user through a corresponding portable communication device, wherein the single image of the at least two users is clicked after synchronizing the one or more parameters associated with the preview image of the at least two users and hardware elements of the at least two portable communication devices in real time;
displaying, at the image customization system, one or more options to the at least one user on the corresponding portable communication devices to set the background of the single image of the at least two users located at different geographical locations, wherein the one or more options is displayed in real time on the mobile applications associated with the image customization system;
receiving, at the image customization system, an input from the at least one user involved in clicking the real-time single image, wherein the input is received in correspondence to the one or more options displayed on the portable communication device to set the background, wherein the input is received in real time;
performing, at the image customization system, one or more operations on the real-time single image of the at least two users located at different geographical locations based on the input from the at least one user to set the background of the real-time single image of the at least two users, wherein the one or more operations comprises:
detecting, at the image customization system, co-ordinates of body parts of the at least one user by utilizing image processing techniques and algorithms, wherein the co-ordinates of the body parts of the at least one user are detected to crop the body parts of the at least one user from the clicked single image of the at least two users located at different geographical locations;
cropping, at the image customization system, the body parts of the at least one user from the clicked single image of the at least two users by using image cropping and scaling algorithms, wherein the cropping of the body parts is done in real time to set the background of the clicked single image with the corresponding background selected by the at least one user by responding to the one or more options in real time;
setting, at the image customization system, the background of the clicked single image of the at least two users located at different geographical locations based on the input of the at least one user to set the background in real time and by utilizing the cropped data associated with the body parts of the at least one user; and
denoising, at the image customization system, the single image of the at least two users located at different geographical locations after setting the selected background, wherein the denoising is done to remove the undesired signal from the clicked single image by using image processing techniques and algorithms in real time.

12. The computer system as claimed in claim 11, wherein the one or more options is related to set a random background, setting the background according to original background, setting the background based on the identified location of the original background scenes, setting the background with a combination of multiple backgrounds, setting the background based on the interest of the users, setting the background based on the festive events, setting the background based on the demographic information of the users, and selection of background from the one or more sources and wherein the one or more sources comprise storage media of the portable communication devices, gallery, album, photos of the portable communication devices and one or more online platforms.

13. The computer system as claimed in claim 11, further comprising, synchronizing, at the image customization system, a plurality of parameters to set the background of the real-time single image according to the cropped body parts of the users, wherein the synchronization is done by using synchronizing techniques and algorithms and wherein the plurality of parameters comprises color, contrast, saturation, brightness, autofocus and ISO of the cropped body parts and the selected background.

14. The computer system as claimed in claim 11, wherein the connection between the at least two portable communication devices is created by utilizing the unique code generated on the first portable communication device associated with the first user.

15. The computer system as claimed in claim 11, wherein the preview image of the at least two user is rendered on the corresponding portable communication devices, wherein the camera of the first portable communication device is triggered when a first signal generator circuitry sends a signal to trigger the camera of the first portable communication device and the camera of the second portable communication device is triggered when a second signal generator circuitry sends a signal to trigger the camera of the second portable communication device.

16. The computer system as claimed in claim 11, wherein the one or more parameters associated with the preview image of the at least two users and hardware elements of the at least two portable communication devices comprises camera features, image, format of images, co-ordinates of image, lightning conditions and screen dimension.

17. The computer system as claimed in claim 11, further comprising customizing, at the image customization system, the single image of the at least two users clicked in real time, wherein at least one of the at least two users customize the single image by adding one or more filters to the single image in real time by rotating the image in left, right, top and bottom directions and wherein the one or more filters is in form of video, gif, 3-d image, 2-d image, animation or a combination of images and videos.

18. The computer system as claimed in claim 11, further comprising, recommending, at the image customization system with the processor, the list of backgrounds to the at least one user based on at least one parameter, wherein the at least one parameter comprises demographic information of the user, festive events, social profile of the user, current location of the user and wherein the recommendation is done in real time.

19. A computer-readable storage medium encoding computer executable instructions that, when executed by at least one processor, performs a method for a real-time customization of a single image of at least two users located at different geographical locations, the method comprising:
receiving, at a computing device, data associated with individual preview image of the at least two users located at different geographical locations and a data associated with at least two portable communication devices, wherein a first portable communication device of the at least two portable communication devices is associated with a first user and a second portable communication device of the at least two portable communication devices is associated with a second user and wherein the data is received after creating a connection between the first portable communication device and the second portable communication device;
enabling clicking, at the computing device, of the single image of the at least two users located at the different geographical locations, wherein the single image of the at least two users is clicked in real time based on an input from the at least one user through a corresponding portable communication device, wherein the single image of the at least two users is clicked after synchronizing the one or more parameters associated with the preview image of the at least two users and hardware elements of the at least two portable communication devices in real time;
displaying, at the computing device, one or more options to the at least one user on the corresponding portable communication devices to set the background of the single image of the at least two users located at different geographical locations, wherein the one or more options is displayed in real time on the mobile applications associated with the image customization system;
receiving, at the computing device, an input from the at least one user involved in clicking the real-time single image, wherein the input is received in correspondence to the one or more options displayed on the portable communication device to set the background, wherein the input is received in real time;
performing, at the computing device, one or more operations on the real-time single image of the at least two users located at different geographical locations based on the input from the at least one user to set the background of the real-time single image of the at least two users, wherein the one or more operations comprises:
detecting, at the computing device, co-ordinates of body parts of the at least one user by utilizing image processing techniques and algorithms, wherein the co-ordinates of the body parts of the at least one user are detected to crop the body parts of the at least one user from the clicked single image of the at least two users located at different geographical locations;
cropping, at the computing device, the body parts of the at least one user from the clicked single image of the at least two users by using image cropping and scaling algorithms, wherein the cropping of the body parts is done in real time to set the background of the clicked single image with the corresponding background selected by the at least one user by responding to the one or more options in real time;
setting, at the computing device, the background of the clicked single image of the at least two users located at different geographical locations based on the input of the at least one user to set the background in real time and by utilizing the cropped data associated with the body parts of the at least one user; and
denoising, at the computing device, the single image of the at least two users located at different geographical locations after setting the selected background, wherein the denoising is done to remove the undesired signal from the clicked single image by using image processing techniques and algorithms in real time.

20. The computer-readable storage medium as claimed in claim 19, wherein the one or more options is related to set a random background, setting the background according to original background, setting the background based on the identified location of the original background scenes, setting the background with a combination of multiple backgrounds, setting the background based on the interest of the users, setting the background based on the festive events, setting the background based on the demographic information of the users, and selection of background from the one or more sources and wherein the one or more sources comprise storage media of the portable communication devices, gallery, album, photos of the portable communication devices and one or more online platforms.
